(19) United States
(12) Patent Application Publication
(10) Pub. No.: US 2006/0171352 A1
(43) Pub. Date: Aug. 3, 2006

(54) Method of assigning address to mobile node in a wireless network

(75) Inventors: Eun-il Seo, Suwon-si (KR); Seung-hwan Oh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/342,571

(22) Filed: Jan. 31, 2006

(30) Foreign Application Priority Data
Feb. 1, 2005 (KR) 2005-0009083

(51) Int. Cl. H04Q 7/00

(52) U.S. Cl. 370/328

(57) ABSTRACT

Disclosed is a method of assigning an address to a mobile node in a tree-structure wireless network, the method including sending a registration request to a management node by a mobile node when the mobile node joins with the wireless network, allocating a static address for the mobile node by the management node responding to the registration request, sending the allocated static address to the mobile node, and setting the static address received from the management node as its own static address by the mobile node. In accordance with the present invention, even if a mobile node moves and its dynamic address is changed, all nodes in the middle of the moved mobile node are not disconnected in communication.

This application claims benefit under 35 U.S.C. § 119 from Korean Patent Application No. 2005-0009083, filed on Feb. 1, 2005, the entire content of which is incorporated herein by reference.

### BACKGROUND OF THE INVENTION

1. Field of the Invention

The present invention relates to a method of assigning an address, and more particularly to a method of assigning an address to a mobile node in a wireless network.

2. Description of the Related Art

FIG. 1A illustrates a network configuration to explain a method of assigning an address to a mobile node which joins a wireless network in accordance with a related art. FIG. 1A shows a tree-structure network where “M” denotes a movable mobile node.

When a mobile node M joins with a wireless network, the mobile node is assigned with an address from a parent node D. With reference to FIG. 1A, the mobile node M is assigned with an address “215. ”

FIG. 1B illustrates a network configuration in which the mobile node M shown in FIG. 1A moved and connected with another node. In comparison with the network configurations in FIG. 1A and FIG. 1B, as the mobile node M moves, the mobile node M is dissociated from the node D and becomes to be associated with a new node B.

Thus, the mobile node M is assigned with a new address from a new parent node, the node B. With reference to FIG. 1B, the new address “161” is assigned to the mobile node M.

As described above, in the case that the parent node of the mobile node M is changed as the mobile mode M moves in a tree-structure network, the mobile node M is also assigned with a new address. As illustrated in FIG. 1A and 1B, the address of the mobile node M is changed from “215” to “161.”

Furthermore, in the case that the address is changed due to the movement of the mobile node M, communication between the mobile node and any nodes in the middle of communication with the mobile node M is disconnected at the time when the address of the mobile node M is changed. Accordingly, a solution to solve the communication disconnection problem is necessary.

### SUMMARY OF THE INVENTION

The present invention has been developed in order to solve the above and other problems associated with the related art. A feature of the present invention is to provide a method of assigning a static address to a mobile node in a tree-structure wireless network so as to prevent a disconnection of communication between the mobile node and other nodes while the mobile node with a dynamic address moves.

In order to achieve a feature of the present invention, there is provided a method of assigning an address to a mobile node in a tree-structure network, including (a) sending a registration request to a management node by a mobile node when the mobile node joins with the wireless network, (b) allocating a static address for the mobile node by the management node responding to the registration request, and sending the static address, which is allocated, to the mobile node, and (c) setting the static address received from the management node as its own static address by the mobile node.

The management node may allocate one of addresses other than addresses already allocated to existing nodes in the wireless network as the static address for the mobile node in the step b).

Furthermore, the management node may be a coordinator.

Additionally, the mobile node may make the registration request by sending to the management node a command packet containing a care-of address of the mobile node and a command frame ID serving as a registration request ID.

The management node may register the mobile node by storing the care-of address and the static address for the mobile node in a table.

Also, the method may further comprise broadcasting the care-of address and the static address of the mobile node over the wireless network by the management node.

According to one aspect, the management node may send the static address for the mobile node to the mobile node by transmitting a packet containing the static address for the mobile node and a command frame ID serving as a registration response ID to the mobile node.

The method may further comprise sending the static address and a new care-of address to the management node by the mobile node when the care-of address of the mobile node is changed, modifying the care-of address, which is previously stored in the table of the mobile node, with the new care-of address by the management node referring the SA transmitted from the mobile node, and broadcasting the static address and the new care-of address of the mobile node over the wireless network by the management node.

The wireless network may also be a ZigBee network.

### BRIEF DESCRIPTION OF THE DRAWINGS

The above aspects and features of the present invention will be more apparent by describing certain exemplary embodiments of the present invention with reference to the accompanying drawings, in which:

FIG. 1A is a wireless network configuration to explain a method of assigning address to a mobile node which joins with a wireless network in accordance with the related art;

FIG. 1B is a wireless network configuration which is the same network shown in FIG. 1A, except that the mobile node has moved and is associated with a different node;

FIG. 2 is a wireless network configuration to explain a method of assigning an address to a mobile node which is associated with a node in a wireless network in accordance with one embodiment of the present invention;

FIG. 3 is flow chart showing a method of assigning an address to a mobile node when the mobile node joins with a wireless network, in accordance with an embodiment of the present invention;

FIG. 4 illustrates formats of a command packet used in a wireless network, including an MN_REG_REQ packet and an MN_REG_REP packet suggested in accordance with one embodiment of the present invention;

FIG. 5 is a wireless network configuration to explain a process in which a mobile node joins with a wireless network by associating with a node in the wireless network, and then moves to a different place and is associated with a different node from the previous node, in accordance with one embodiment of the present invention; and

FIG. 6 is a flow chart showing an operation process when a mobile node associated with a node moves and then is associated with a different node in a wireless network after movement, in accordance with an exemplary embodiment of the present invention.

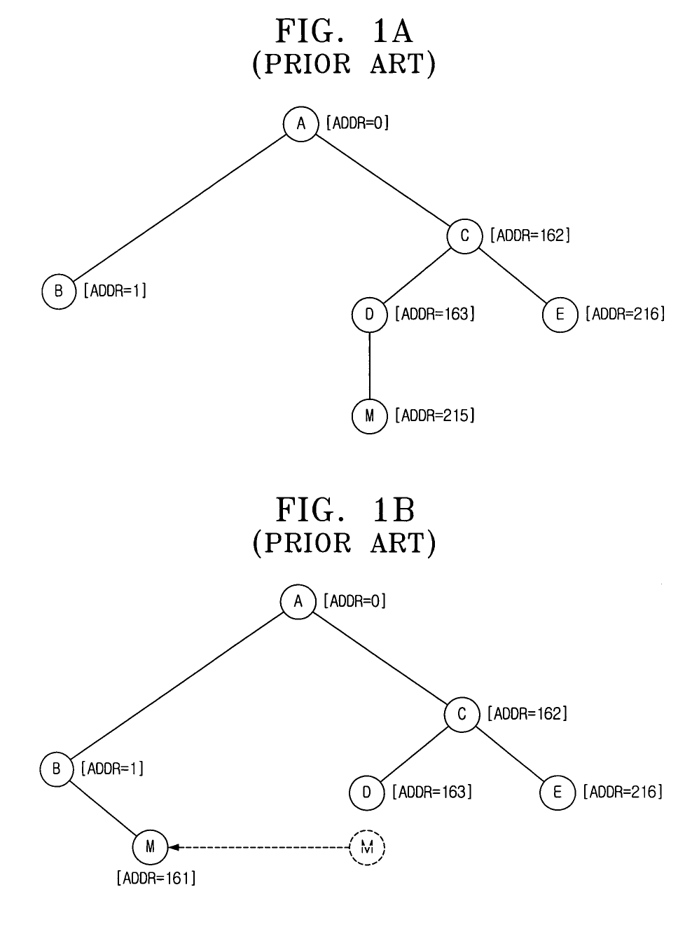

### DETAILED DESCRIPTION OF THE EXEMPLARY EMBODIMENTS

Certain embodiments of the present invention will be described in greater detail with reference to the accompanying drawings.

The present invention is applicable to a tree-structure wireless network. ZigBee is a representative tree-structure wires network.

In accordance with one embodiment of the present invention, a mobile node is assigned with two addresses when the mobile node joins with an arbitrary node in a wireless network. The two addresses are a “care-of address” (herein referred as “COA”) and a “static address” (herein referred as “SA”). They are different in an aspect that the COA is an address that may vary as the mobile node moves and the SA is an address that does not vary, regardless of the movement of the mobile node.

In addition, the COA is assigned from a parent node but the SA is assigned from a management node. The management node means a node assigning SAs to mobile nodes when the mobile nodes join with a wireless network. Here, a coordinator is suitable to serve as the management node.

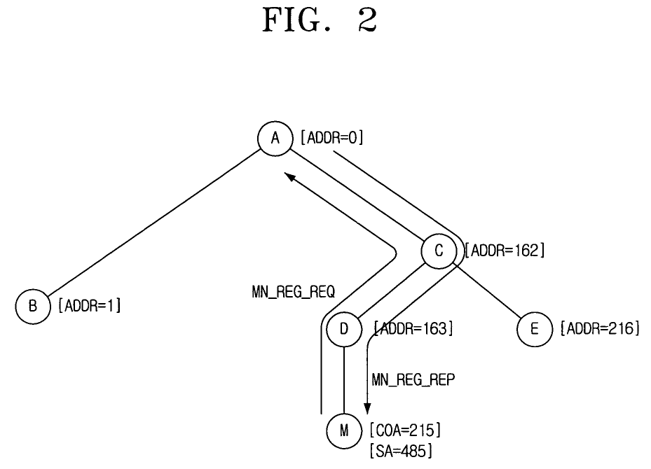

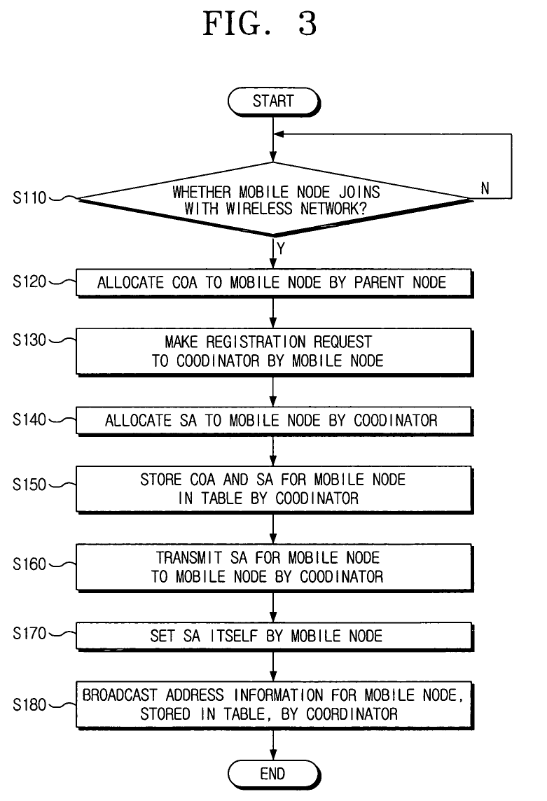

With reference to FIG. 2 and FIG. 3, a process of assigning a COA and a SA to a mobile node will be described when the mobile node joins with a wireless network.

FIG. 2 and FIG. 3 illustrate a network configuration and a flow chart, respectively, to explain a method of assigning addresses to a mobile node when the mobile node joins with a wireless network, in accordance with one embodiment of the present invention.

Referring to FIG. 2, “M” denotes a mobile node, “D” denotes a node associated with the mobile node M (a parent node of the mobile node M), and “A” denotes a coordinator.

First, when the mobile node M joins with a wireless network (S110), and more particularly with the parent node D, the mobile node M is assigned with a COA from the parent node D (S120). With reference to FIG. 2, the COA assigned to the mobile node M in step S120 is “215.”

Next, the mobile node M requests a registration to the coordinator A (S130). Step S130 can be realized as the mobile node M sends a “packet for mobile node registration request” (hereinafter referred as “MN_REG_REQ packet”) to the coordinator A.

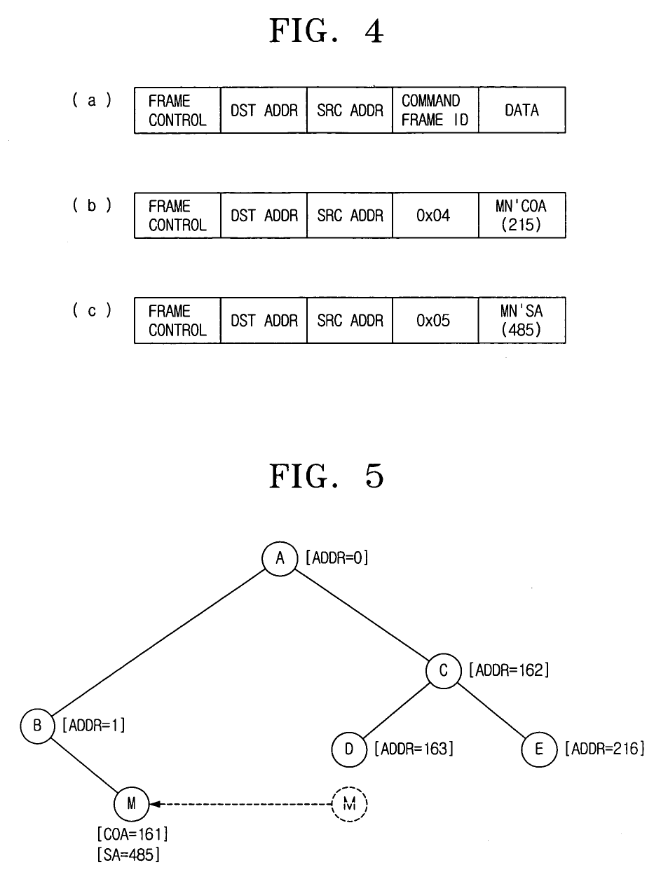

Before describing the MN_REG_REQ packet, a command packet for use in a ZigBee network, a representative tree-structure wireless network, will be briefly described first. Referring to (a) of FIG. 4, a conceptual diagram of a command packet for use in the ZigBee network is illustrated.

With reference to (a) of FIG. 4, the command packet includes a header comprised of a frame control, a destination address DST ADDR, a source address SRC ADDR, a pay load comprised of a “command frame ID” (hereinafter referred as “CF ID”), and data.

Here, the command packet is RREQ when the CF ID is “0×01,” the command packet is RREP when the CF ID is “0×02,” and the command packet is RERR when the CF ID is “0×03”.

In this embodiment, when the command packet corresponding to the CF ID “0×04” is called MN_REG_REQ packet which is a mobile node registration request packet, and the command packet corresponding to the CF ID “0×05” is called MN_REG_REP packet which is a mobile node registration response packet.

Further, when a “mobile node's COA” (herein after referred as “MN'COA”) is contained in data in the MN_REG_REQ packet. The format of the MN_REG_REQ packet as described above is shown in (b) of FIG. 4. Referring to (b) of FIG. 4, the CF ID is “0×04” and the MN_REG_REQ packet contains the MN' COA “215”.

Referring to FIG. 3, the coordinator A to which the MN_REG_REQ packet is transmitted, allocates the SA to the mobile node M (S140). In more detail, the coordinator A allocates the SA to the mobile node M by choosing one of possibly several addresses other than addresses already assigned to nodes existing in the wireless network to which the mobile node M belongs.

Referring to FIG. 3, if the wireless network includes 484 nodes, addresses 1 to 484 can be assigned to the existing nodes. At this time, 485, 486, 487, . . . , are not assigned addresses and therefore can be chosen as the SA for the mobile node M. Accordingly, the coordinator A allocates one of 485, 486, 487, . . . , as the SA for the mobile node M.

Any of the addresses can be the SA for the mobile node M as long as they are not already assigned to existing nodes in the wireless network. That is, any assignment method and equation can be used to assign the addresses, and there is no limitation thereto.

Next, the coordinator A stores the COA and the SA for the mobile node M in a “mobile node registration entry table” (hereinafter referred to as “table”) (S150). Thus, the mobile node M is registered by the coordinator A.

The COA stored in the table are acquired from the MN_REG_REQ packet transmitted from the mobile node M in step S130 and the SA in the table is assigned by the coordinator in step S140.

In step S140, in the case that the coordinator A assigns the SA 485 to the mobile node M, the table can be constituted as in Table 1.

TABLE 1

| Mobile Node′ Care | Mobile Node′ Static |
|---|---|
| Of Address | Address |
| 215 | 485 |
| . | . |
| . | . |
| . | . |

Next, as a response to the registration request of the mobile mode M, the coordinator A sends the MN_REG_REP packet containing the SA for the mobile node M to the mobile node M (S160).

The format of MN_REG_REP packet is shown in (c) of FIG. 4. As described above, CF ID of the MN_REG_REP packet is “0×05.” Further, it is shown that the MN_REG_REP packet contains 485 as the SA for the corresponding mobile node.

Next, the mobile node refers the SA in the MN_REG_REP packet received from the coordinator A and set it as its own SA (S170).

Next, the coordinator A broadcasts address information for the mobile node M, which is stored in the table (S180). The address information about the mobile node M includes the COA and the SA for the mobile node M. As a result, other nodes B, C, D and E existing in the wireless network recognize the COA and the SA of the mobile node M.

When a mobile node joins with a wireless network, a method of assigning a COA and a SA for the mobile node is described above.

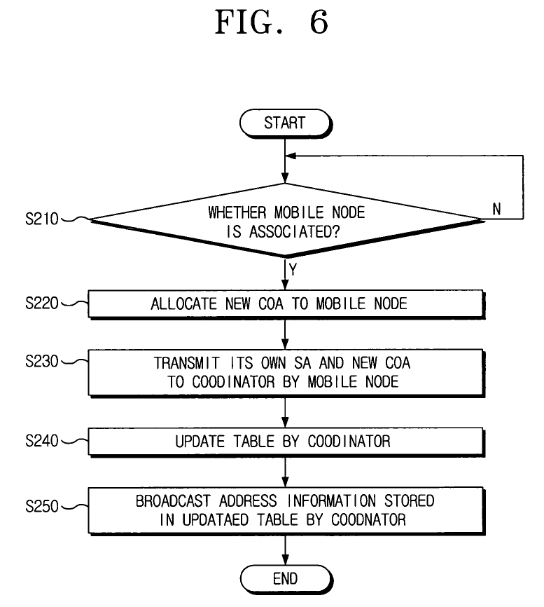

Now, a process where a mobile nodes moves to another place, is dissociated from a previous parent node D and is associated with another parent node is described below in detail with reference to FIG. 5 and FIG. 6.

FIG. 5 and FIG. 6 illustrate a network configuration and a flow chart, respectively, to explain a process where a mobile nodes moves to another place, is dissociated from a previous parent node and is associated with a new parent node in a wireless network, in accordance with one embodiment of the present invention.

In comparison with FIG. 2 and FIG. 5, it is shown that the mobile node M is dissociated from the previous parent node D as it moves, and is associated with the node B.

In the process, first when the mobile node M is associated with another node B (a new parent node B) (S210), it is assigned with a new COA from the new parent node B (S220). With reference to FIG. 5, the mobile node M is assigned with the new COA “161” in step S220.

As the mobile node M is associated with the new parent node B, the COA for the mobile node is changed from “215” to “161” but the SA is not changed, because the COA is assigned from the parent node but the SA is assigned from the coordinator A.

Next, the mobile node M sends its own SA and the new COA to the coordinator (S230). Then the coordinator A updates the stored table. In more detail, the coordinator refers the SA which is not changed and replaces the previous COA with the new COA, thereby completing the update of the table.

In the case that the mobile node M is assigned with the new COA “161” in step S220, the table will be updated as in table 2.

TABLE 2

| Mobile Node′ Care Of Address | Mobile Node′ Static Address |
|---|---|
| 161 | 485 |
| . | . |
| . | . |
| . | . |

Next, the coordinator broadcasts the address information stored in the updated table over the corresponding wireless network (S250). The address information for the mobile node M contains the COA and the SA. Thus, all the other nodes B, C, D and E existing in the wireless network recognize the replaced COA of the mobile node M.

Accordingly, even if the COA of the mobile node M is changed as the mobile node M moves, all the other nodes in the middle of communication with the mobile node M can recognize the replaced COA of the mobile node M, so that communication between them is not disconnected.

As described above, in accordance with exemplary embodiments of the present invention, it is possible to assign a static address to a mobile node in a tree-structure wireless network. Accordingly, even in the case that a dynamic address for a mobile node is changed as the mobile node moves, communication between the moved mobile node and any other mobile nodes in the middle of communication with the moved mobile will not be disconnected.

The foregoing embodiment and advantages are merely exemplary and are not to be construed as limiting the present invention. The present teaching can be readily applied to other types of embodiments. Also, the description of the exemplary embodiments of the present invention is intended to be illustrative, and not to limit the scope of the claims, and many alternatives, modifications, and variations will be apparent to those skilled in the art.

What is claimed is:

1. A method of assigning an address to a mobile node over a wireless network, comprising:
sending a registration request to a management node from a mobile node when the mobile node joins into the wireless network;
allocating a static address for the mobile node by the management node responding to the registration request, and sending the static address to the mobile node; and
setting the static address received from the management node as a static address for the mobile node.

2. The method of assigning an address according to claim 1, wherein the management node allocates one of addresses other than addresses already allocated to other existing nodes in the wireless network as the static address for the mobile node.

3. The method of assigning an address according to claim 1, wherein the management node is a coordinator.

4. The method of assigning an address according to claim 1, wherein sending a registration request comprises sending the management node a command packet containing a care-of address of the mobile node and a command frame ID serving as a registration request.

5. The method of assigning an address according to claim 4, wherein responding to the registration request comprises:
registering the mobile node by storing the care-of address and the static address for the mobile node in a table of the management node.

6. The method of assigning an address according to claim 5, further comprising:
broadcasting the care-of address and the static address of the mobile node over the wireless network by the management node.

7. The method of assigning an address according to claim 1, wherein the management node sends the static address for the mobile node to the mobile node by transmitting a packet containing the static address for the mobile node and a command frame ID serving as a registration response ID to the mobile node.

8. The method of assigning an address according to claim 5, further comprising:
sending the static address and a new care-of address to the management node by the mobile node when the care-of address of the mobile node is changed;
modifying the care-of address, which is previously stored in the table with the new care-of address by the management node using the static address transmitted from the mobile node; and
broadcasting the static address and the new care-of address of the mobile node over the wireless network by the management node.

9. The method of assigning an address according to claim 1, wherein the wireless network is a ZigBee network.
